(19) United States
(12) Patent Application Publication
(10) Pub. No.: US 2019/0382080 A1
(43) Pub. Date: Dec. 19, 2019

(54) Transmission for a Bicycle

(71) Applicant: ZF Friedrichshafen AG, Friedrichshafen (DE)

(72) Inventors: Johannes Kaltenbach, Friedrichshafen (DE); Valerie Engel, Markdorf (DE); Uwe Griesmeier, Markdorf (DE); Matthias Wesa, Ravensburg (DE); Michael Wechs, Weißensberg (DE); Jens Moraw, Markdorf (DE); Gerhard Niederbrucker, Friedrichshafen (DE)

(21) Appl. No.: 16/470,041

(22) PCT Filed: Nov. 24, 2017
(86) PCT No.: PCT/EP2017/080369

§ 371 Date: Jun. 14, 2019

(30) Foreign Application Priority Data
Dec. 15, 2016 (DE) 10 2016 225 145.7

(51) Int. Cl. B62M 11/18; F16H 3/44; F16H 57/10; B62M 11/14

(52) U.S. Cl. CPC B62M 11/18; F16H 3/44; F16H 57/10; F16H 2306/00; F16H 2200/2007; F16H 2200/201; B62M 11/145

(57) ABSTRACT

A transmission for a bicycle includes at least four shift elements, an input shaft (1), a first planetary gear set (PS1) which is operatively connected to the input shaft (1), a second planetary gear set (PS2) which is operatively connectable to the input shaft (1), and an output shaft (2). The input shaft (1) is rotationally fixed to a ring gear of the first planetary gear set (PS1), and the output shaft (2) is rotationally fixed to a carrier of the first planetary gear set (PS1).

### FIELD OF THE INVENTION

The invention relates generally to a transmission for a bicycle that includes at least four shift elements, an input shaft, a first planetary gear set which is operatively connected to the input shaft, a second planetary gear set which is operatively connectable to the input shaft, and an output shaft.

The invention also relates generally to a bottom bracket that includes such a transmission. In addition, the invention relates generally to a bicycle that includes the bottom bracket or the transmission.

### BACKGROUND

A multitude of transmissions which can be utilized in a bicycle is known from the prior art. For example, a transmission is known from U.S. Pat. No. 2,011,177 911 A1, which includes three series-connected planetary transmissions having a speed increasing ratio. The transmission includes a total of seven planet gear planes, including numerous stepped planetary gears, and so the design complexity of the transmission is very high.

### SUMMARY OF THE INVENTION

Example aspects of the invention provide a transmission which has low design complexity.

In certain embodiments, a transmission includes at least four shift elements, an input shaft, a first planetary gear set which is operatively connected to the input shaft, a second planetary gear set which is operatively connectable to the input shaft, and an output shaft, and the transmission is characterized in that the input shaft is rotationally fixed to a ring gear of the first planetary gear set and is rotationally fixed to a carrier of the first planetary gear set.

The transmission according to example aspects of the invention has the advantage that a 4-speed transmission can be made available, which requires no stepped planetary gears. The transmission has a simple and compact configuration and the assembly of the transmission can take place quickly. In addition, the transmission has good efficiency and can be cost-effectively manufactured. The transmission according to the invention also has the advantage that the transmission is suitable for an application in a bicycle, in particular in connection with a front-mounted splitter group/unit or a rear-mounted splitter group/unit.

A shaft is not to be understood exclusively as a, for example, cylindrical, rotatably mounted machine element for transmitting torques, but rather is to be understood to also be general connecting elements which connect individual components or elements to one another, in particular, connecting elements which connect multiple elements to one another in a rotationally fixed manner.

The first planetary gear set may be a plus planetary gear set and/or the second planetary gear set may be a minus planetary gear set. A minus planetary gear set corresponds to a planetary gear set includes a carrier, on which the planetary gears are rotatably mounted, and including a sun gear and a ring gear, wherein the tooth system of at least one of the planetary gears intermeshes with the tooth system of the sun gear as well as with the tooth system of the ring gear, whereby the ring gear and the sun gear rotate in opposite directions of rotation when the sun gear rotates while the carrier is held.

In contrast thereto, a plus planetary gear set differs from the minus planetary gear set in that the plus planetary gear set includes inner and outer planetary gears which are rotatably mounted on the carrier. The tooth system of the inner planetary gears intermeshes, in this case, with the tooth system of the sun gear, on the one hand, and with the tooth system of the outer planetary gears, on the other hand. In addition, the tooth system of the outer planetary gears intermeshes with the tooth system of the ring gear. As a result, the ring gear and the sun gear rotate in the same direction when the carrier is held.

In one particular embodiment, a sun gear of the second planetary gear set may be rotationally fixable to the input shaft with the aid of a first shift element of the at least four shift elements. In addition, the sun gear may be rotationally fixable to a transmission housing with the aid of a second shift element of the at least four shift elements. A carrier of the second planetary gear set may be rotationally fixed to a sun gear of the first planetary gear set. A ring gear of the second planetary gear set may be rotationally fixable to the transmission housing with the aid of a third shift element of the at least four shift elements. In addition, the ring gear of the second planetary gear set may be rotationally fixable to the output shaft with the aid of a fourth shift element of the at least four shift elements.

The transmission housing may be an integral part of a bottom bracket shell, i.e., may be designed as one piece with the bottom bracket shell. Alternatively, the transmission housing may be designed separately from the bottom bracket shell and, in the assembled condition of the transmission, may be arranged in a cavity of the bottom bracket shell. The transmission housing may be arranged and designed in such a way that it does not rotate during the operation of the transmission, but rather is stationary.

The first planetary gear set and the second planetary gear set may be arranged in such a way that the input shaft does not extend through a plane which encompasses the second planetary gear set. Alternatively, the first planetary gear set and the second planetary gear set may be arranged in such a way that the input shaft extends through the plane which encompasses the second planetary gear set. In particular, the plane may encompass the ring gear, the carrier, and the sun gear of the second planetary gear set. In the end, the arrangement of the first and the second planetary gear sets relative to one another can take place depending on the installation space available in the transmission and/or in the bottom bracket shell.

The transmission according to example aspects of the invention has the advantage that the shift elements are readily accessible to an actuator system. The second and the third shift elements may be designed as brakes and/or arranged in a radially outer area of the transmission, which simplifies the accessibility. The first and the fourth shift elements may each be designed as a clutch or a free-wheel unit. In an embodiment of the first and the fourth shift elements as a free-wheel unit in each case, it is advantageous that neither an engagement or an actuator system are necessary. In addition, the first and the fourth shift elements only need to apply small supporting torques, and so the free-wheel units can be designed to be small.

The input shaft may be rotationally fixable to the crankshaft. In this embodiment, the output shaft may be rotationally fixed to a traction mechanism carrier, such as a sprocket or a belt pulley. In the case of a use of the transmission in the bicycle, a torque applied to the traction mechanism carrier may be transmitted to a rear wheel with the aid of a traction mechanism, such as a chain or a belt.

In the end, a transmission is realized, in which precisely four gears can be made available with the aid of precisely two planetary gear sets and/or precisely four shift elements. A first gear can be a direct gear, i.e., can have a ratio of one (1). The remaining gears can have a speed increasing ratio, i.e., a ratio of less than one (1).

In one particular embodiment, the transmission may include a third planetary gear set which is operatively connected to the first planetary gear set and/or the second planetary gear set. The third planetary gear set may be drivingly connected upstream or downstream from the first and the second planetary gear sets. The third planetary gear set may be a minus planetary gear set.

An element of the third planetary gear set may be rotationally fixable to another element of the third planetary gear set with the aid of a fifth shift element. When a fifth shift element is engaged, the third planetary gear set is interlocked, i.e., has a ratio of one (1). It is very particularly advantageous when the ring gear of the third planetary gear set is rotationally fixable to the sun gear of the third planetary gear set with the aid of the fifth shift element. This is advantageous since, in this case, low supporting torques are to be applied by the fifth shift element. Alternatively, it is possible, of course, to arrange the fifth shift element in such a way that a carrier of the third planetary gear set is rotationally fixable to a sun gear of the third planetary gear set or to a ring gear of the third planetary gear set with the aid of the fifth shift element.

The ring gear of the third planetary gear set may be rotationally fixable to the transmission housing with the aid of a sixth shift element. The sixth shift element may be designed as a brake and the fifth shift element may be designed as a clutch or a free-wheel unit.

In one particular embodiment, during a traction operation of the transmission, the third planetary gear set may be drivingly connected upstream from the first and the second planetary gear sets, i.e., may form a front-mounted splitter group. The input shaft, the first planetary gear set, the second planetary gear set, the output shaft, and the four shift elements form a main group in this embodiment. A carrier of the third planetary gear set may be rotationally fixable to the crankshaft with the aid of a further input shaft and a sun gear of the third planetary gear set may be rotationally fixed to the input shaft. In this embodiment, the output shaft may be rotationally fixed to the traction mechanism carrier.

Alternatively, an embodiment is possible, in which, during a traction operation of the transmission, the third planetary gear set is drivingly connected downstream from the first and the second planetary gear sets, i.e., forms a rear-mounted splitter group. The input shaft, the first planetary gear set, the second planetary gear set, the output shaft, and the four shift elements form a main group in this embodiment. The output shaft may be rotationally fixed to the carrier of the third planetary gear set and the sun gear of the third planetary gear set may be rotationally fixed to a further output shaft. The further output shaft may be rotationally fixed to the traction mechanism carrier. In this embodiment, the input shaft may be rotationally fixable to the crankshaft.

The front-mounted splitter group or the rear-mounted splitter groupcan provide precisely two gears and/or include precisely two shift elements, namely the fifth and the sixth shift elements. A first gear can be a direct gear and a second gear can be a speed increasing ratio. The front-mounted splitter group or the rear-mounted splitter groupmay include precisely one planetary gear set, namely the third planetary gear set. In addition, the third planetary gear set does not include a stepped planetary gear. In a combination of the front-mounted splitter group or the rear-mounted splitter group with the main group, a group transmission may be realized.

Regardless of whether the transmission includes the front-mounted splitter group or the rear-mounted splitter groupin addition to the main group, all variants yield the same transmission ratio range, i.e., the function of the transmission is identical, overall, in all variants. Differences exist in terms of the speed and torque ratios resulting at the individual planetary gear sets. Since the front-mounted splitter group or the rear-mounted splitter group, on the one hand, and the main group, on the other hand, include the direct gear as the first gear, the torque load is similar in all variants. Greater differences result in the case of the speeds since the planetary gear sets positioned further toward the rear in the power flow are operated in some gears with an input speed which is already higher.

The clutches or brakes utilized in the transmission may be designed to be form-locking or friction-locking. If the aforementioned shift elements are designed as free-wheel units, it is advantageous that, on the one hand, the main group and/or, on the other hand, the front-mounted splitter group or the rear-mounted splitter groupare/is not interlocked, in order to prevent an interlock of the transmission in the event of a reversal of the direction of rotation at the input or at the output. This can be realized in that the fifth shift element of the front-mounted splitter group or the rear-mounted splitter group group and/or the second and the third shift elements of the main group are designed as a unilaterally acting brake, such as an engageable overrunning brake.

In the end, an 8-speed transmission can be realized by coupling the main group, which provides four gears, to a front-mounted splitter group or a rear-mounted splitter group, each of which provides two gears. The transmission is advantageous, since eight gears can be realized or implemented with the aid of precisely three planetary gear sets, and so the transmission has a short installation length. In addition, the transmission has suitable values for the stationary transmission ratios, and so the planetary gear sets can have a small diameter. One further advantage is that precisely three shift elements may be designed as brakes. The remaining shift elements may be designed as free-wheel units. This is advantageous since at least one, in particular precisely three, actuators must be present for actuating the three shift elements designed as brakes.

In one particular embodiment, the transmission may include an electric machine which is drivingly connected downstream from the first and/or the second and/or the third planetary gear set(s). In particular, the electric machine may be drivingly operatively connected to the output shaft or to the further output shaft. The driving downstream connection of the electric machine offers the advantage that the planetary gear sets are not loaded with the torque provided by the electric machine. The electric machine also has the advantage that the electric machine can assist the cyclist in the operation. As a result, close gear steps are not necessary, since, due to the electric machine, muscle power has little significance for the propulsion.

The electric machine includes at least a rotationally fixed stator and a rotatably mounted rotor and is configured for converting electrical energy into mechanical energy in the form of rotational speed and torque when operated as a motor and for converting mechanical energy into electrical energy in the form of current and voltage when operated as a generator.

The electric machine may be arranged so as to be offset, in particular in the radial direction, with respect to a central axis of the transmission and/or the crankshaft. In particular, a central axis of the electric machine may extend in parallel to a central axis of the transmission. This offers the advantage that the electric machine may be arranged in an area of the transmission and/or the bottom bracket shell, in which sufficient space is available for accommodating the electric machine. In addition, an inner diameter of the electric machine may be freely selected, since the crankshaft, which does not belong to the transmission, does not extend through the electric machine.

The connection of the electric machine to the output shaft or the further output shaft may take place with the aid of a chain drive and/or a belt drive and/or a spur gear drive and/or a transmission gearing. In addition, a free-wheel unit may be arranged in the power flow between the electric machine and the output shaft or the further output shaft. The free-wheel unit offers the advantage that, during operation without the electric machine, no losses are caused by the rotating rotor of the electric machine.

A bottom bracket that includes the transmission according to example aspects of the invention is very particularly advantageous, wherein the input shaft or the further input shaft is rotationally fixed to the crankshaft. The bottom bracket may include a bottom bracket shell, wherein the transmission is arranged in a cavity of the bottom bracket shell. The transmission may be modularly designed. Therefore, the transmission, in entirety, may be introduced into or removed from the cavity. A bicycle that includes the transmission or the bottom bracket is very particularly advantageous.

### BRIEF DESCRIPTION OF THE DRAWINGS

The subject matter of example aspects of the invention is schematically represented in the figures and is described in the following with reference to the figures, wherein identical or identically operating elements are mostly provided with the same reference characters. Wherein:

FIG. 1: shows a schematic of the transmission according to a first exemplary embodiment;

FIG. 2: shows a schematic of the transmission according to the invention, according to a second exemplary embodiment;

FIG. 3: shows a shift pattern of the transmissions represented in FIGS. 1 and 2;

FIG. 4: shows a schematic of the transmission according to the invention, according to a third exemplary embodiment;

FIG. 5: shows a schematic of the transmission according to the invention, according to a fourth exemplary embodiment;

FIG. 6: shows a table of values for the stationary transmission ratio of the planetary gear sets; and

FIG. 7: shows a shift pattern of the transmissions according to the invention, represented in FIG. 3 and FIG. 4.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

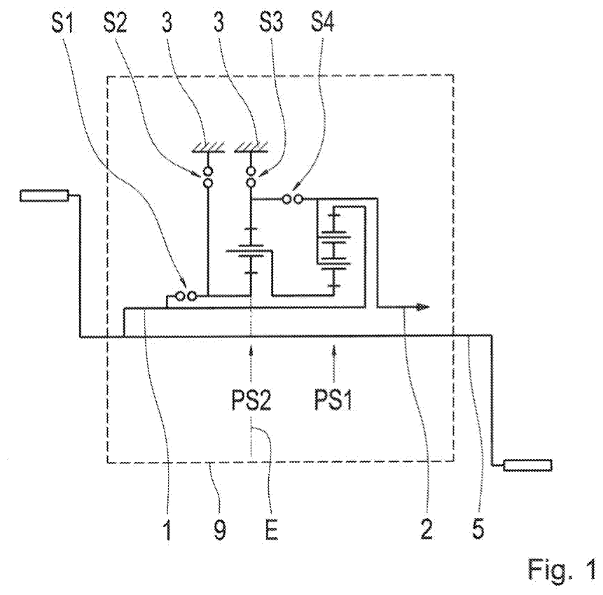

FIG. 1 shows a transmission according to the invention, according to a first exemplary embodiment, which is rotationally symmetrical with respect to a crankshaft 5. Only the upper half of the transmission is represented in FIG. 1.

The transmission includes four shift elements, namely a first shift element S1, a second shift element S2, a third shift element S3, and a fourth shift element S4. The first shift element S1 and the fourth shift element S4 are designed as clutches. The second shift element S2 and the third shift element S3 are designed as brakes.

In addition, the transmission includes an input shaft 1, a first planetary gear set PS1 which is operatively connected to the input shaft 1, a second planetary gear set PS2, and an output shaft 2. The input shaft 1 is rotationally fixed to a ring gear of the first planetary gear set PS1 and a carrier of the first planetary gear set PS1 is rotationally fixed to the output shaft 2. The output shaft 2 is arranged coaxially to the crankshaft 5 and is rotationally fixed to a traction mechanism carrier (not represented). The first planetary gear set PS1 is designed as a plus planetary gear set and the second planetary gear set PS2 is designed as a minus planetary gear set.

The input shaft 1 is rotationally fixable to a sun gear of the second planetary gear set PS2 with the aid of the first shift element S1. The sun gear of the second planetary gear set PS2 is additionally rotationally fixable to a transmission housing 3 with the aid of a second shift element S2. A carrier of the second planetary gear set PS2 is rotationally fixed to a sun gear of the first planetary gear set PS1. A ring gear of the second planetary gear set PS2 is rotationally fixable to the transmission housing 3 with the aid of a third shift element S3 and is rotationally fixable to the output shaft 2 with the aid of the fourth shift element S4.

The first planetary gear set PS1 and the second planetary gear set PS2 are arranged coaxially to one another. In addition, the first planetary gear set PS1 and the second planetary gear set PS2 are arranged coaxially to the crankshaft 5. In addition, the first planetary gear set PS1 and the second planetary gear set PS2 are arranged in such a way that the input shaft 1 extends through a plane E in order to connect to the ring gear of the first planetary gear set PS1. In this case, the plane E encompasses the ring gear, the carrier, and the sun gear of the second planetary gear set PS2. In addition, the plane E is arranged perpendicularly with respect to the crankshaft 5.

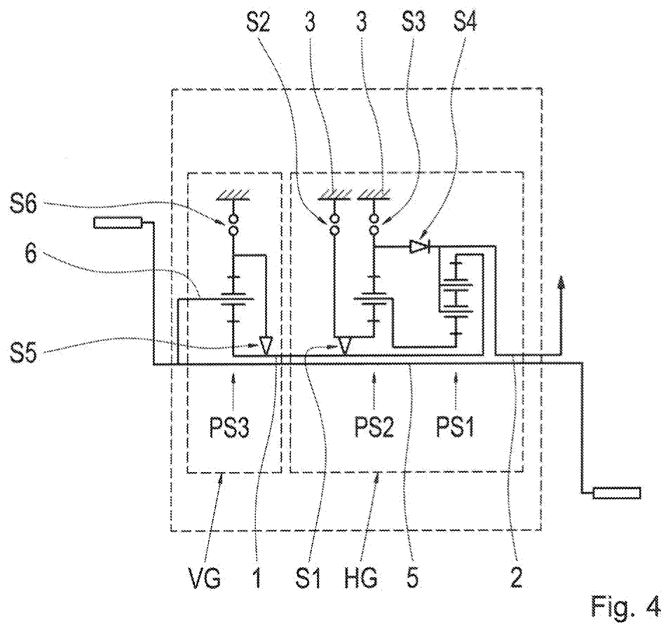

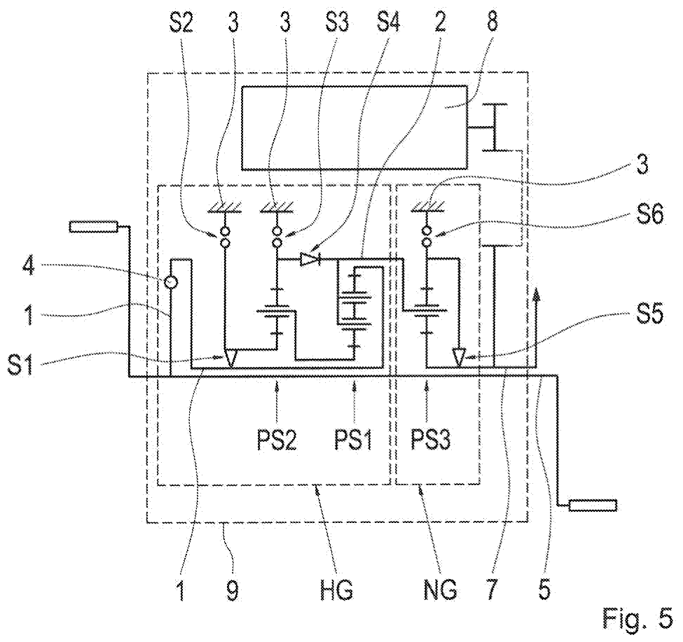

The transmission is arranged in a cavity of a bottom bracket shell 9. The transmission shown in FIG. 1 forms a main group HG which is operatively connected to further range change groups, as is apparent from FIGS. 4 and 5.

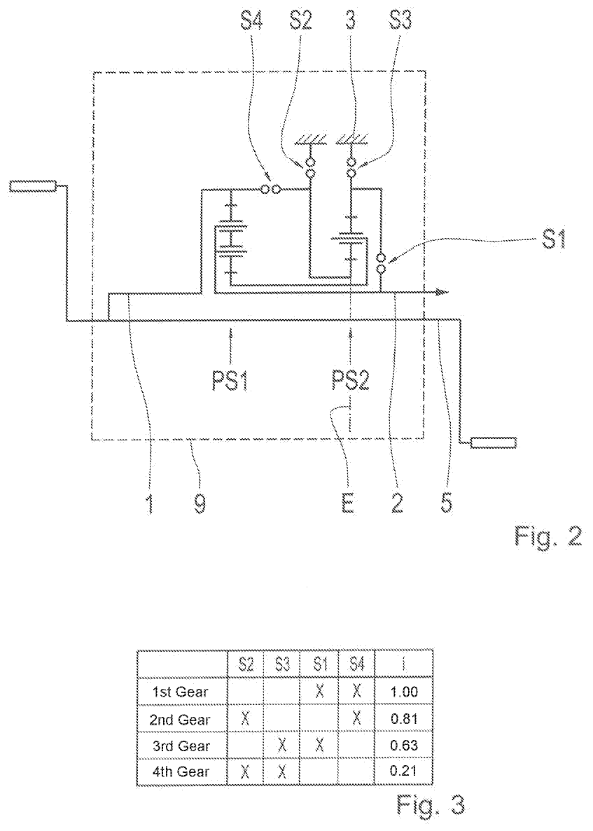

FIG. 2 shows a transmission according to a second exemplary embodiment. The transmission represented in FIG. 2 differs from the transmission represented in FIG. 1 in terms of the arrangement of the first planetary gear set PS1 and the second planetary gear set PS2 with respect to one another. In particular, the second planetary gear set PS2 is arranged in such a way that the input shaft 1 does not extend through the plane E in order to connect to the ring gear of the first planetary gear set PS1.

FIG. 3 shows the shift pattern for the transmissions represented in FIGS. 1 and 2. The character “x” indicates that the particular shift element is engaged. In addition, the shift pattern indicates the ratio “i” between the input shaft 1 and the output shaft 2 and, therefore, the traction mechanism carrier, for each gear.

As is apparent from FIG. 3, the transmission has precisely four gears, wherein a first gear is a direct gear. The remaining gears have a speed increasing ratio. In the transmissions represented in FIGS. 1 and 2, the first planetary gear set PS1 may have a stationary transmission ratio of two (2.0) and the second planetary gear set PS2 can have a stationary transmission ratio of negative one and six-tenths (−1.6). In the case of a minus planetary gear set, the stationary transmission ratio corresponds to the negative ratio of the number of teeth of the ring gear and the sun gear. In a plus planetary gear set, the stationary transmission ratio corresponds to the positive ratio of the number of teeth of the ring gear and the sun gear.

FIG. 4 shows the transmission according to a third exemplary embodiment. The transmission differs from the transmission represented in FIG. 1 in that the transmission includes a third planetary gear set PS3 which forms a front-mounted splitter group VG which is drivingly connected upstream from the main group HG. In particular, the third planetary gear set PS3 is drivingly connected upstream from the first planetary gear set PS1 and the second planetary gear set PS2, with respect to a power flow from the crankshaft 5 to the output shaft 2, during a traction operation.

A ring gear of the third planetary gear set PS3 is rotationally fixable to a sun gear of the third planetary gear set PS3 with the aid of a fifth shift element S5. In addition, the ring gear of the third planetary gear set PS3 is rotationally fixable to the transmission housing 3 with the aid of a sixth shift element S6. A carrier of the third planetary gear set PS3 is rotationally fixed to the crankshaft 5 with the aid of a further input shaft 6. The sun gear of the third planetary gear set PS3 is rotationally fixed to the input shaft 1.

The fifth shift element S5 is designed as a free-wheel unit and the sixth shift element S6 is designed as a brake. One further difference from the transmission represented in FIG. 1 is that the first shift element S1 and the fourth shift element S4 are each designed as a free-wheel unit.

The transmission according to a fourth exemplary embodiment represented in FIG. 5 differs from the transmission represented in FIG. 4 in that the third planetary gear set PS3 does not form a front-mounted splitter group VG, but rather a rear-mounted splitter group NG. This means, the third planetary gear set PS3 is drivingly connected downstream from the main group HG, with respect to the power flow from the crankshaft 2 to a further output shaft 7, during a traction operation.

The output shaft 2 is rotationally fixed to the carrier of the third planetary gear set PS3. The sun gear of the third planetary gear set PS3 is rotationally fixed to the further output shaft 7 which is rotationally fixed to the traction mechanism carrier which is not represented in the figure. The input shaft 1 is rotationally fixed to the crankshaft 5.

One further difference is that the transmission includes an electric machine 8 which is operatively connected to the output shaft 7, as represented by the dashed line. The connection of the electric machine 8 to the output shaft 7 may take place via a differential drive, a spur gear drive, a chain drive, and/or a belt drive, wherein the connection is not represented in FIG. 4. The connection of the electric machine 8 takes place in an area which is drivingly connected downstream from the rear-mounted splitter group NG.

The electric machine 8 is not designed to be rotationally symmetrical with respect to the crankshaft 5. In particular, the electric machine 8 is offset in the radial direction with respect to the crankshaft 5.

One further difference is that the transmission includes a torque sensor 4, with the aid of which the torque transmitted from the crankshaft 5 to the input shaft 1 can be measured. The torque sensor 9 may be designed in the shape of a disk. Another embodiment and/or arrangement of the torque sensor 9 is also possible, of course.

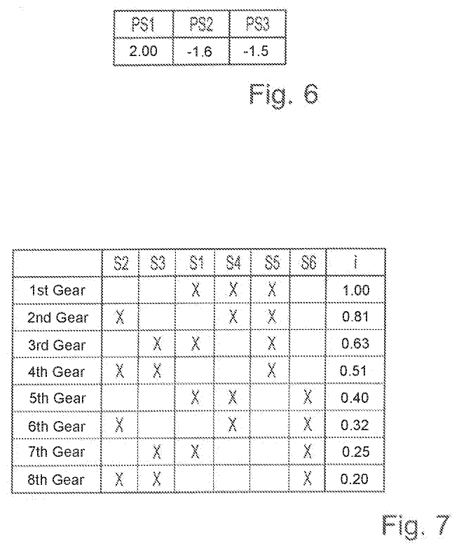

FIG. 6 shows a table of values for the stationary transmission ratio of the three planetary gear sets represented in FIGS. 4 and 5. As is apparent from the table, the first planetary gear set PS1 has a stationary transmission ratio of two (2.0), the second planetary gear set PS2 has a stationary transmission ratio of negative one and six-tenths (−1.6), and the third planetary gear set PS3 has a stationary transmission ratio of negative one and a half (−1.5).

FIG. 7 shows a shift pattern for the transmissions represented in FIGS. 4 and 5. The character “x” indicates the shift elements which are engaged in the particular gear. If the shift element is designed as a free-wheel unit, the character “x” means the free-wheel unit interlocks. This takes place independently, without an external actuation. The shift elements designed as brakes are engaged with the aid of at least one actuator.

It is also apparent from the shift pattern that the transmissions represented in FIGS. 4 and 5 each have eight gears. In addition, the shift pattern indicates the ratio “i” between the crankshaft 5 and the traction mechanism carrier for each gear.

Modifications and variations can be made to the embodiments illustrated or described herein without departing from the scope and spirit of the invention as set forth in the appended claims.

### REFERENCE CHARACTERS

1 input shaft
2 output shaft
3 transmission housing
4 torque sensor
5 crankshaft
6 further input shaft
7 further output shaft
8 electric machine
9 bottom bracket shell
E plane
S1 first shift element
S2 second shift element
S3 third shift element
S4 fourth shift element
S5 fifth shift element
S6 sixth shift element
HG main transmission
NG rear-mounted splitter group
VG front-mounted splitter group
PS1 first planetary gear set
PS2 second planetary gear set
PS3 third planetary gear set

1-13: (canceled)

14. A transmission for a bicycle, comprising:
at least four shift elements;
an input shaft (1);
a first planetary gear set (PS1) operatively connected to the input shaft (1);
a second planetary gear set (PS2) operatively connectable to the input shaft (1); and
an output shaft (2),
wherein the input shaft (1) is rotationally fixed to a ring gear of the first planetary gear set (PS1), and the output shaft (2) is rotationally fixed to a carrier of the first planetary gear set (PS1).

15. The transmission of claim 14, wherein:
the first planetary gear set (PS1) is a plus planetary gear set;
the second planetary gear set (PS2) is a minus planetary gear set; or
the first planetary gear set (PS1) is the plus planetary gear set, and the second planetary gear set (PS2) is the minus planetary gear set.

16. The transmission of claim 14, wherein:
a sun gear of the second planetary gear set (PS2) is rotationally fixable to the input shaft (1) with a first shift element (S1), is rotationally fixable to a transmission housing (3) with a second shift element (S2), or is rotationally fixable to the input shaft (1) with the first shift element (S1) and to the transmission housing (3) with the second shift element (S2);
a carrier of the second planetary gear set (PS2) is rotationally fixed to a sun gear of the first planetary gear set (PS1); and/or
a ring gear of the second planetary gear set (PS2) is rotationally fixable to the transmission housing (3) with a third shift element (S3), is rotationally fixable to the output shaft (2) with a fourth shift element (S4), or is rotationally fixable to the transmission housing (3) with the third shift element (S3) and to the output shaft (2) with the fourth shift element (S4).

17. The transmission of claim 14, wherein:
the first planetary gear set (PS1) and the second planetary gear set (PS2) are arranged in such a way that the input shaft (1) does not extend through a plane (E) which encompasses the second planetary gear set (PS2); or
the first planetary gear set (PS1) and the second planetary gear set (PS2) are arranged in such a way that the input shaft (1) extends through a plane (E) which encompasses the second planetary gear set (PS2).

18. The transmission of claim 14, wherein the input shaft (1) is rotationally fixed to a crankshaft (5).

19. The transmission of claim 14, further comprising a third planetary gear set (PS3) operatively connected to the first planetary gear set (PS1), to the second planetary gear set (PS2), or to both the first and second planetary gear sets (PS1, PS2).

20. The transmission of claim 19, wherein:
an element of the third planetary gear set (PS3) is rotationally fixable to another element of the third planetary gear set (PS3) with a fifth shift element (S5);
a ring gear of the third planetary gear set (PS3) is rotationally fixable to a transmission housing (3) with a sixth shift element (S6); or
the element of the third planetary gear set (PS3) is rotationally fixable to the another element of the third planetary gear set (PS3) with the fifth shift element (S5), and the ring gear of the third planetary gear set (PS3) is rotationally fixable to the transmission housing (3) with the sixth shift element (S6).

21. The transmission of claim 19, wherein the input shaft (1) is rotationally fixable to a crankshaft (5), and wherein:
a carrier of the third planetary gear set (PS3) is rotationally fixed to the crankshaft (5) with a further input shaft (6);
a sun gear of the third planetary gear set (PS3) is rotationally fixed to the input shaft (1); or
the carrier of the third planetary gear set (PS3) is rotationally fixed to the crankshaft (5) with the further input shaft (6), and the sun gear of the third planetary gear set (PS3) is rotationally fixed to the input shaft (1).

22. The transmission of claim 19, wherein:
the output shaft (2) is rotationally fixed to a carrier of the third planetary gear set (PS3);
a sun gear of the third planetary gear set (PS3) is rotationally fixed to a further output shaft (7); or
the output shaft (2) is rotationally fixed to the carrier of the third planetary gear set (PS3), and the sun gear of the third planetary gear set (PS3) is rotationally fixed to the further output shaft (7).

23. The transmission of claim 14, further comprising an electric machine (8), wherein:
the electric machine (8) is drivingly connected downstream from one or more of the first planetary gear set (PS1), the second planetary gear set (PS2), and the third planetary gear set (PS3);
the electric machine (8) is operatively connected or operatively connectable to the output shaft (2) or a further output shaft (7); or
the electric machine (8) is drivingly connected downstream from one or more of the first planetary gear set (PS1), the second planetary gear set (PS2), and the third planetary gear set (PS3), and the electric machine (8) is operatively connected or operatively connectable to the output shaft (2) or the further output shaft (7).

24. A bottom bracket, comprising the transmission of claim 14, wherein the input shaft (1) or a further input shaft (6) is rotationally fixed to the crankshaft (5).

25. The bottom bracket of claim 24, further comprising a bottom bracket shell (9), wherein the transmission is arranged in a cavity of the bottom bracket shell (9).

26. A bicycle comprising, the transmission of claim 14.

27. A bicycle, comprising the bottom bracket of claim 24.
